(19) United States
(12) Patent Application Publication
(10) Pub. No.: US 2009/0088196 A1
(43) Pub. Date: Apr. 2, 2009

(54) Communication System, Communication Device, and Transmission Power Control Method

(75) Inventors: Masamitsu Nishikido, Kanagawa (JP); Chiharu Yamazaki, Tokyo (JP); Shigeru Kimura, Kanagawa (JP); Yuuya Tounai, Kanagawa (JP)

Correspondence Address: HOGAN & HARTSON L.L.P., 1999 AVENUE OF THE STARS, SUITE 1400, LOS ANGELES, CA, 90067, US

(73) Assignee: KYOCERA CORPORATION, Kyoto-shi, Kyoto (JP)

(21) Appl. No.: 11/993,953

(22) PCT Filed: Jun. 28, 2006
(86) PCT No.: PCT/JP2006/312911

§ 371 Date: Dec. 26, 2007

(30) Foreign Application Priority Data
Jun. 29, 2005 (JP) 2005-190641

(51) Int. Cl. H04B 7/005

(52) U.S. Cl. 455/522

(57) ABSTRACT

Transmission power control is carried out according to the necessary received power of a receiving communication device.

A mobile communication system (10) is characterized in that a base station device (20a) transmits a reception scheme of a communication signal; and a mobile station device (30a) includes a reception scheme acquisition part (303) receiving the transmitted reception scheme; a transmission power controller (307a) determining a transmission power at which a communication signal is transmitted; and a transmission BB processing part (308) transmitting the communication signal to the base station device (20a) at the determined transmission power.

### TECHNICAL FIELD

The present invention relates to a communication system, a communication device, and a transmission power control method.

### BACKGROUND ART

A form of control referred to as open-loop transmission power control is one form of conventional transmission power control in a mobile communication system.

In open-loop transmission power control, a communication device (e.g., mobile station device) controls the transmission power of signals transmitted thereby on the basis of the received power of a signal received from the receiving communication device (e.g., base station device) that receives communication signals transmitted by the communication device.

Patent Document 1 describes a technique for controlling communication (modulation scheme, transmission power, and the like) between the mobile station device and the base station device on the basis of radio wave propagation characteristics estimation information generated using the position of the mobile station device and map information.

### Patent Document 1: Japanese Laid-open Patent Application No. 2004-15337

### DISCLOSURE OF THE INVENTION

### Problem to be Solved by the Invention

The received power required by the receiving communication device in order to correctly demodulate the received signal varies according to reception diversity, adaptive array, or another reception scheme. However, when using the conventional open-loop transmission power control, the control cannot be performed in accordance with the difference of the necessary received power of the pair of communication devices, and there have been cases in which only inadequate results could be obtained.

Therefore, an object of the present invention is to provide a communication system, a communication device, and a transmission power control method with which it is possible to control the transmission power in accordance with the received power required by the receiving communication device.

### Means for Solving the Problem

In order to solve the abovementioned problems, the communication system of the present invention is a communication system for carrying out communication between a first communication device and a second communication device, wherein the second communication device includes necessary received power information transmission means for transmitting necessary received power information related to a received power necessary to receive a communication signal; and the first communication device includes necessary received power information receiving means for receiving the transmitted necessary received power information; transmission power determining means for determining a transmission power at which a communication signal is transmitted on the basis of the received necessary received power information; and first communication signal transmission means for transmitting the communication signal to the second communication device at the determined transmission power.

According to this configuration, since the first communication device receives the necessary received power information from the second communication device, it is possible to carry out transmission power control in the first communication device according to the necessary received power of the second communication device.

In the communication system, the necessary received power information may be information indicating a reception scheme by which the second communication device receives the communication signal transmitted by the first communication signal transmission means.

It is thereby possible to determine the transmission power at which the first communication device transmits a communication signal on the basis of the reception scheme of the second communication device (e.g., reception diversity or adaptive array).

In the communication system, the second communication device may further include second communication signal transmission means for transmitting a communication signal; and the first communication device may further include communication signal receiving means for receiving the communication signal transmitted by the second communication signal transmission means; and received power information acquisition means for acquiring received power information indicating a received power of the received communication signal; wherein the transmission power determining means determines the transmission power at which the communication signal is transmitted further on the basis of the acquired received power information.

According to this configuration, the first communication device can further correct the transmission power determined by open-loop transmission power control on the basis of the necessary received power information of the second communication device.

In the communication system, the first communication device may further include received power fluctuation index calculating means for calculating a received power fluctuation index indicating fluctuation tendencies of the received power indicated by the acquired received power information; and the transmission power determining means may determine the transmission power at which the communication signal is transmitted further on the basis of the calculated received power fluctuation index.

In the open-loop transmission power control, the received power of the received signal is necessary in order to determine the transmission power. Therefore, the transmission power is determined on the basis of the received power acquired shortly before, and there is a slight time lag. Due to this time lag, when there are considerable fluctuations in the received power, there may be cases in which only insufficient results are obtained even when open-loop transmission power control has been carried out.

According to the configuration described above, the first communication device can carry out transmission power control in accordance with the fluctuation tendencies of the received power. Therefore, the first communication device can carry out transmission power control according to the fluctuations in the received power as long as the fluctuation tendencies do not suddenly change.

In the communication system, the first communication device may further include storage means for storing a transmission power correction value in correspondence with the received power fluctuation index for each item of necessary received power information; and the transmission power determining means may correct the received necessary received power information on the basis of the transmission power correction value stored in correspondence with the calculated received power fluctuation index; and determine the transmission power at which the communication signal is transmitted.

According to the configuration described above, the first communication device stores the transmission power correction value in correspondence with the received power fluctuation index for each item of necessary received power information. The first communication device can therefore acquire a transmission power correction value that is suitable for the calculated received power fluctuation index and the received necessary received power information. The transmission power can be appropriately determined by correcting the transmission power on the basis of the transmission power correction value.

The communication device according to the present invention includes necessary received power information receiving means for receiving, from a receiving communication device, necessary received power information related to a necessary received power of the receiving communication device; transmission power determining means for determining the transmission power at which a communication signal is transmitted on the basis of the received necessary received power information; and communication signal transmission means for transmitting the communication signal to the receiving communication device at the determined transmission power.

According to this configuration, the necessary received power is received from the receiving communication device. Therefore, it is possible to carry out transmission power control according to the necessary received power of the receiving communication device.

In the communication device, the necessary received power information may be information indicating a reception scheme by which the receiving communication device receives the communication signal transmitted by the communication signal transmission means.

It is thereby possible to determine the transmission power at which the communication signal is transmitted on the basis of the reception scheme of the receiving communication device (e.g., reception diversity or adaptive array).

The transmission power control method according to the present invention includes a necessary received power information receiving step of receiving, from a receiving communication device, necessary received power information related to a necessary received power of the receiving communication device; a transmission power determining step of determining the transmission power at which a communication signal is transmitted on the basis of the received necessary received power information; and a communication signal transmitting step of transmitting the communication signal to the receiving communication device at the determined transmission power.

A program according to the present invention causes a computer to function as necessary received power information receiving means for receiving, from a receiving communication device, necessary received power information related to a necessary received power of the receiving communication device; transmission power determining means for determining the transmission power at which a communication signal is transmitted on the basis of the received necessary received power information; and communication signal transmission means for transmitting the communication signal to the receiving communication device at the determined transmission power.

### BRIEF DESCRIPTION OF THE DRAWINGS

FIG. 1 is a block diagram of a mobile communication system according to Embodiments 1 to 3 of the present invention;

FIG. 2 is a system block diagram of a base station device according to Embodiments 1 to 3 of the present invention;

FIG. 3 is a system block diagram of a mobile station device according to Embodiments 1 to 3 of the present invention;

FIG. 4 shows a relationship between the reception scheme and the necessary average received power in the communication device according to Embodiments 1 to 3 of the present invention;

FIG. 5 is a functional block diagram of the base station device and the mobile station device according to Embodiment 1 of the present invention;

FIG. 6 shows a transmission power correction value storage table A according to Embodiment 1 according to the present invention;

FIG. 7 is a process flowchart of the mobile station device according to Embodiment 1 of the present invention;

FIG. 8 is a process flowchart of the mobile station device according to Embodiment 1 of the present invention;

FIG. 9 shows a relationship between the reception scheme, received power fluctuation index, and the necessary average received power in the communication device according to Embodiment 2 and 3 of the present invention;

FIG. 10 is a functional block diagram of the base station device and the mobile station device according to Embodiment 2 of the present invention;

FIG. 11 shows a transmission power correction value storage table B according to Embodiment 2 of the present invention;

FIG. 12 is a functional block diagram of the base station device and the mobile station device according to Embodiment 3 of the present invention;

FIG. 13 shows a transmission power correction value storage table C according to Embodiment 3 of the present invention; and

FIG. 14 is a process flowchart of the mobile station device according to Embodiment 3 of the present invention.

### BEST MODE FOR CARRYING OUT THE INVENTION

### Embodiment 1

Embodiment 1 of the present invention will be described with reference to the drawings.

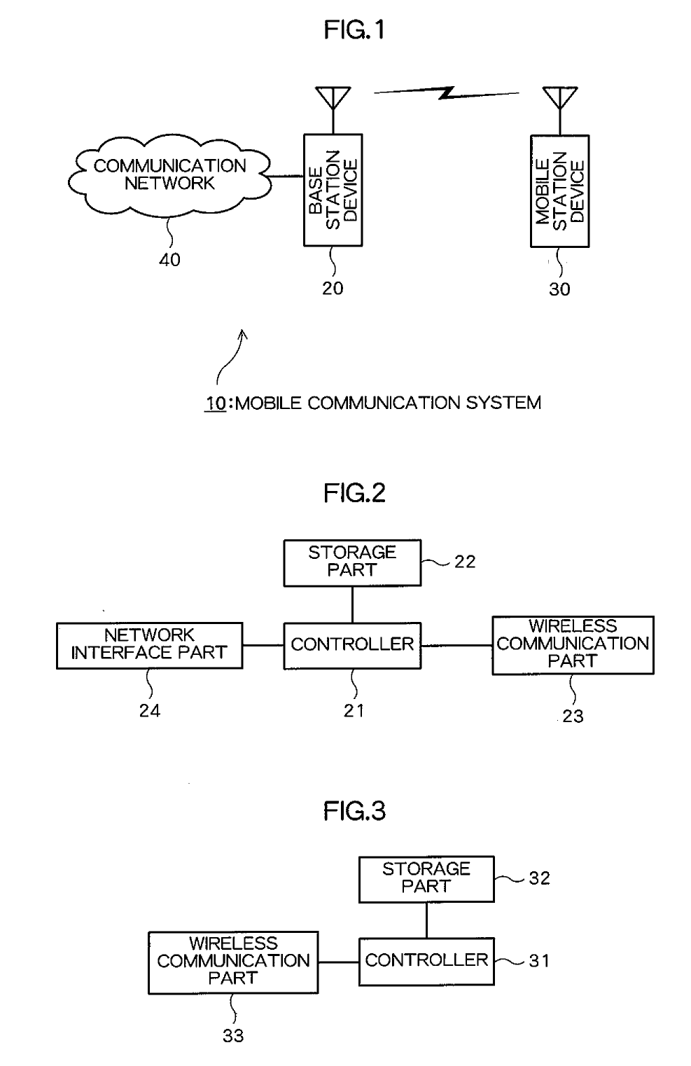

FIG. 1 is a block diagram of a mobile communication system 10 according to the present embodiment. As shown in this diagram the mobile communication system 10 according to the present embodiment includes a base station device 20, a mobile station device 30, and a communication network 40. The base station device 20 communicates simultaneously with a plurality of mobile station devices 30, and relays communication carried out between the mobile station device 30 and the communication network 40.

The base station device 20 includes a controller 21, a storage part 22, a wireless communication part 23, and a network interface part 24, as shown in FIG. 2.

The controller 21 controls the components of the base station device 2 and executes processing related to telephone calls, data communication and the like. The controller 21 modulates communication data inputted from the network interface part 24, and outputs the results to the wireless communication part 23 as a base band communication signal. The controller 21 also determines the transmission power at which the wireless communication part 23 sends the communication signal into the radio section. The controller 21 also demodulates and decodes the communication signal inputted from the wireless communication part 23, and outputs the results to the network interface part 24 as communication data.

The storage part 22 acts as working memory for the controller 21. The storage part 22 also holds programs and parameters related to various processes carried out by the controller 21. The storage part 22 also stores a transmission power correction value storage table A (described below) in correspondence with reception scheme information that indicates a reception scheme (described below) of the wireless communication part 23.

The wireless communication part 23 has one or a plurality of antennas. The wireless communication part 23 receives communication data transmitted from the mobile station device 30 by using a predetermined reception scheme (described below) that is determined according to the number of antennas, heterodynes the communication data, and outputs the results to the controller 21. The wireless communication part 23 also heterodynes the communication data inputted from the controller 21 and outputs the results via the antenna, according to instructions inputted from the controller 21. During this transmission, the wireless communication part 23 transmits the communication signal at the transmission power designated by the controller 21.

The network interface part 24 is connected to the communication network 40. The network interface part 24 receives communication data transmitted from communication network 40 and outputs the communication data to the controller 21. The network interface part 24 also transmits communication data to the communication network 40 according to instructions from the controller 21.

The mobile station device 30 includes a controller 31, a storage part 32, and a wireless communication part 33, as shown in FIG. 3.

The controller 31 controls the components of the mobile station device 30 and executes processes related to telephone calls, data communication and the like. The controller 31 modulates communication data, outputs the results to the wireless communication part 33 as a base band communication signal, and determines the transmission power at which the wireless communication part 33 sends the communication data into the radio section. The controller 31 also demodulates and decodes communication data inputted from the wireless communication part 33, and acquires the communication data.

The storage part 32 acts as working memory for the controller 31. The storage part 32 also holds programs and parameters related to various processes carried out by the controller 31. The storage part 32 also stores a transmission power correction value storage table A (described below) in correspondence with reception scheme information that indicates a reception scheme (described below) of the wireless communication part 33.

The wireless communication part 33 has one or a plurality of antennas. The wireless communication part 33 receives communication data transmitted from the base station device 20 by using a predetermined reception scheme (described below) that is determined according to the number of antennas, heterodynes the communication data, and outputs the results to the controller 31. The wireless communication part 33 also heterodynes the communication data inputted from the controller 31 and outputs the results via the antenna, according to instructions inputted from the controller 31. During this transmission, the wireless communication part 33 transmits the communication data at the transmission power designated by the controller 31.

A variety of reception schemes can be used in the wireless communication part 23 and the wireless communication part 33. Examples of such reception schemes include diversity-disabled, diversity-enabled, and adaptive array schemes. The reception sensitivity when receiving the communication data varies among these schemes. A higher level of reception sensitivity corresponds to a higher likelihood that the controller 21 or controller 31 can demodulate and decode communication data received at a low received power. For example, when a diversity-enabled scheme is used, the wireless communication parts select the communication data received in a better state from communication data received using two antennas. As a result, the reception sensitivity can be improved. When an adaptive array scheme is used, the wireless communication parts can form an electrical directivity toward the communication device that transmitted the communication data. As a result, the reception sensitivity can be even further improved.

In these reception schemes, there is an average received power threshold (necessary average received power) at which the controller 21 or the controller 31 can demodulate and decode. The necessary average received power is data related to the received power necessary for the communication device to receive a communication signal.

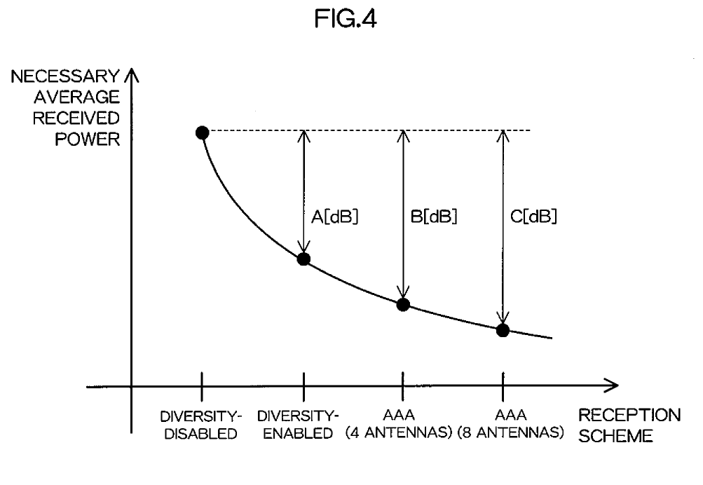

FIG. 4 shows a relationship between the reception scheme and the necessary average received power. As shown in this diagram, the necessary average received power is the highest when diversity reception is not used (referred to as the diversity-disabled scheme in FIG. 4). When diversity reception is used (referred to as the diversity-enabled scheme in FIG. 4), the necessary average received power is next highest (A (dB) lower than when diversity reception is not used). In a case where adaptive array reception is carried out using four antennas (referred to as AAA (four antennas) in FIG. 4), the necessary average received power decreases further (B (dB) (A<B) lower than the case in which diversity reception is not used). In a case where adaptive array reception is carried out using eight antennas (referred to as AAA (eight antennas) in FIG. 4), the necessary average received power is the lowest (C (dB) (B<C) lower than the case in which diversity reception is not used).

The base station device 20 and the mobile station device 30 control the transmission power using the relationship between the reception scheme and the necessary average received power. The following is a description of a process in the mobile station device 30 for controlling the transmission power according to the reception scheme of the base station device 20. This process is the same as the process in base station device 20 for controlling the transmission power according to the reception scheme of the mobile station device 30.

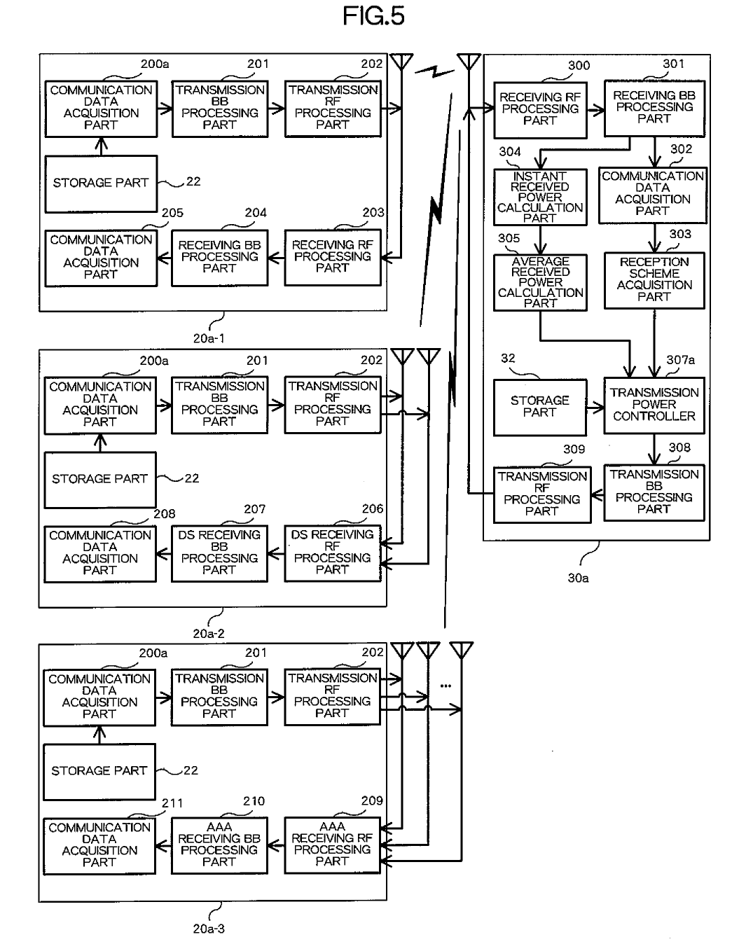

FIG. 5 is a functional block diagram of the base station device 20a and mobile station device 30a according to the present embodiment. As shown in this diagram, the mobile station device 30a has, in functional terms, a receiving RF processing part 300; a receiving BB processing part 301; a communication data acquisition part 302; a reception scheme acquisition part 303; an instant received power calculation part 304; an average received power calculation part 305; a transmission power controller 307a; a transmission BB processing part 308; and a transmission RF processing part 309. The base station device 20a-1 has one antenna, and is a base station device 20a which does not perform the diversity. The base station device 20a-1 has, in functional terms, a communication data acquisition part 200a; a transmission BB processing part 201; a transmission RF processing part 202; a receiving RF processing part 203; a receiving BB processing part 204; and a communication data acquisition part 205. The base station device 20a-2 has two antennas, and is a base station device 20a which performs the diversity. The base station device 20a-2 has, in functional terms, a communication data acquisition part 200a; a transmission BB processing part 201; a transmission RF processing part 202; a DS receiving RF processing part 206; a DS receiving BB processing part 207; and a communication data acquisition part 208. The base station device 20a-3 has three or more antennas, and is a base station device 20a that performs adaptive array reception. The base station device 20a-3 has, in functional terms, a communication data acquisition part 200a; a transmission BB processing part 201; a transmission RF processing part 202; an AAA receiving RF processing part 209; an AAA receiving BB processing part 210; and a communication data acquisition part 211.

The communication data acquisition part 200a of each of the base station devices 20a reads the reception scheme information stored in the storage part 22. The communication data acquisition part 200a encodes the read reception scheme information, and outputs the results to the transmission BE processing part 201 along with other communication data as communication data.

The transmission BB processing part 201 acquires a baseband signal by modulating the communication data. The transmission BB processing part 201 outputs the acquired baseband signal to the transmission RF processing part 202. The transmission RF processing part 202 converts the frequency of the inputted baseband signal to a radio frequency, and sends the resulting signal into the radio section via the antenna(s).

The receiving RF processing part 300 receives, via the antenna(s), the signal sent into the radio section by the transmission RF processing part 202, converts the signal to the baseband signal having the base band frequency, and outputs the resulting signal to the receiving BB processing part 301. The receiving BB processing part 301 demodulates the inputted baseband signal, acquires the communication signal, and outputs the resulting signal to the communication data acquisition part 302. The communication data acquisition part 302 decodes the inputted communication signal, and acquires the communication data.

The reception scheme acquisition part 303 acquires the reception scheme information of the base station device 20a that is in the process of transmitting or that is about to start transmitting, from the communication data acquired by the communication data acquisition part 302. The reception scheme acquisition part 303 outputs the acquired reception scheme information to the transmission power controller 307a.

The instant received power calculation part 304 sequentially acquires the power of the baseband signals inputted to the receiving BB processing part 301 as received power values, and outputs the resulting values to the average received power calculation part 305. The average received power calculation part 305 acquires the moving average of the inputted received power values, and outputs the results to the transmission power controller 307a as an average received power value.

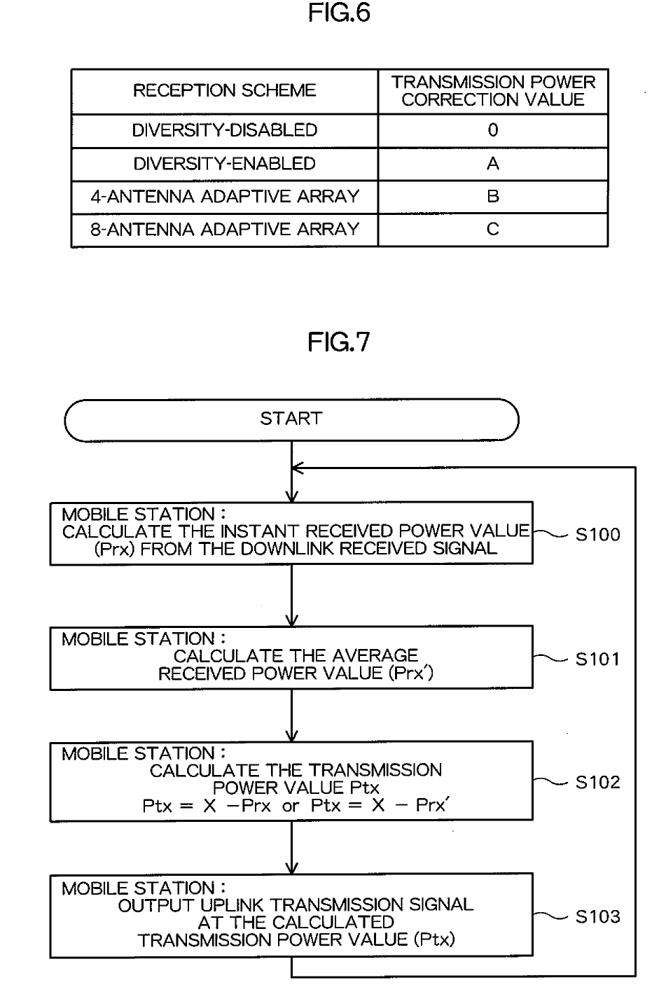

The transmission power controller 307a reads the transmission power correction value stored in the transmission power correction value storage table A from the storage part 32 according to the reception scheme indicated by the reception scheme information. FIG. 6 is an example of the transmission power correction value storage table A. As shown in this diagram, the transmission power correction values are stored in correspondence with the reception scheme in the transmission power correction value storage table A. The transmission power controller 307a acquires the transmission power correction value stored in correspondence with the reception scheme indicated by the reception scheme information.

The transmission power controller 307a determines the transmission power on the basis of the acquired transmission power correction value. The transmission power controller 307a generally determines the transmission power value Ptx by using the open-loop transmission power control shown in Equation (1) below. X is a parameter (open-loop transmission power control parameter) having a prescribed value, and is stored in the storage part 32. Prx′ is the average received power value (moving average value of the received power value Prx) inputted from the average received power calculation part 305.

Ptx=X−Prx′ (1)

The transmission power controller 307a corrects the open-loop transmission power control parameter X on the basis of the transmission power correction value. Specifically, the open-loop transmission power control parameter is obtained by subtracting the transmission power correction value from X.

Using the open-loop transmission power control parameter obtained by this correction, the transmission power controller 307a determines the transmission power value Ptx according to the Equation (1), and instructs the transmission BB processing part 308 to output the baseband signal at the transmission power having the determined transmission power value.

The transmission BB processing part 308 modulates the communication signal encoded in a communication data acquisition part (not shown), and outputs the results to the transmission RF processing part 309 at the transmission power indicated by the transmission power controller 307a. The transmission RF processing part 309 converts the frequency of the baseband signal inputted from the transmission BB processing part 308 to the radio frequency, and sends the resulting signal into the radio section via the antenna.

Each of the base station devices 20a receives the radio signal that reaches the antennas using the respective reception schemes.

In the base station device 20a-1, the receiving REF processing part 203 receives the radio signal that reaches one antenna, heterodynes the radio signal to obtain a baseband signal, and outputs the baseband signal to the receiving BB processing part 204. The receiving BB processing part 204 demodulates the baseband signal to obtain a communication signal, and outputs the communication signal to the communication data acquisition part 205. The communication data acquisition part 205 decodes the communication signal and acquires the signal as communication data.

In the base station device 20a-2, the DS receiving RF processing part 206 receives the radio signals that reach two antennas. The DS receiving RF processing part 206 then heterodynes these signals to obtain baseband signals, and outputs the baseband signals to the DS receiving BB processing part 207. The DS receiving BB processing part 207 demodulates the baseband signals to obtain communication signals, and outputs the communication signals to the communication data acquisition part 208. The communication data acquisition part 208 decodes the communication signals to obtain communication data. The communication data acquisition part 208 also selects the communication data received in a better state from the two sets of communication data. The DS receiving RF processing part 206 or the DS receiving BB processing part 207 may also combine the signals received by the antennas.

In the base station device 20a-3, the AAA receiving RF processing part 209 receives the radio signals that reach the plurality of antennas. The AAA receiving RF processing part 209 then heterodynes these signals to obtain baseband signals, and outputs the baseband signals to the AAA receiving BB processing part 210. The AAA receiving BB processing part 210 demodulates the baseband signals to obtain communication signals, combines the communication signals, and outputs the communication signals to the communication data acquisition part 211. The communication data acquisition part 211 decodes the communication signals to obtain communication data.

Next, the process in the mobile station device 30 will be described in detail with reference to a process flowchart.

FIG. 7 is a flowchart of the basic process of the transmission power control in the mobile station device 30. As shown in this diagram, the mobile station device 30 calculates the instant received power value (Prx) of the downlink received signal (the direction of communication from the base station device 20 to the mobile station device 30) (S100). The mobile station device 30 then calculates the average received power value (Prx′), which is the moving average of the calculated instant received power value (S101). Next, the mobile station device 30 calculates the transmission power value Ptx by using the Equation (1) (S102). As shown in FIG. 7, Prx may be used in the Equation (1) instead of Prx′. The mobile station device 30 transmits an uplink communication signal (the direction of communication from the mobile station device 30 to the base station device 20) at the transmission power having the calculated transmission power value (Ptx) (S103).

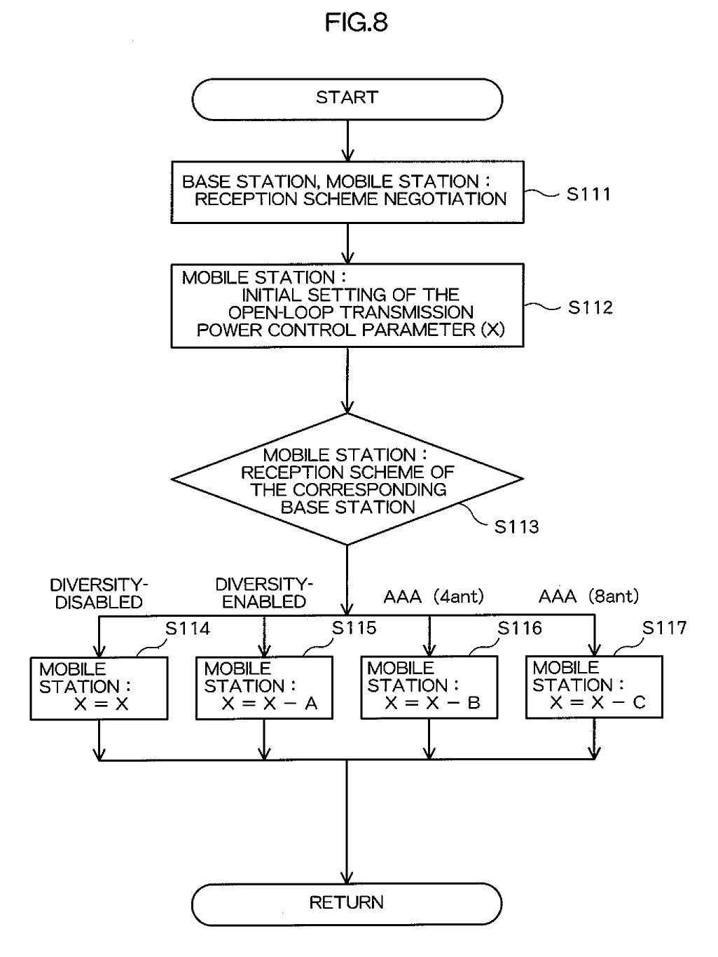

FIG. 8 is a flowchart of the open-loop transmission power control parameter correction process in the mobile station device 30. As shown in this diagram, negotiation (conversion) of the reception scheme is first carried out between the mobile station device 30 and the base station device 20. Specifically, this negotiation is carried out by transmitting and receiving the reception scheme information. This process can be carried out once by each of the base station devices 20. In this case, the mobile station device 30 preferably stores the reception scheme of the base station device 20 in correspondence with identification information for identifying the base station device 20.

Next, the mobile station device 30 initially sets the value of X by using the open-loop transmission power control parameter stored in the storage part 32 (S112). The mobile station device 30 then reads the transmission power correction value stored in correspondence with the reception scheme of the base station device 20 that is in the process of communicating or that is about to begin communication. The mobile station device 30 then corrects the value of X using the read transmission power correction value (S113 to S117). The mobile station device 30 uses the resulting value of X as the open-loop transmission power control parameter.

The mobile communication system 10 carries out transmission power control using the relationship between the reception scheme and the necessary average received power, as described above. Specifically, one of the communication devices among the base station device 20 and the mobile station device 30 receives necessary received power information from the other communication device, allowing one of the communication devices to perform transmission power control according to the necessary received power of the other communication device. The transmission power at which one of the communication devices transmits a communication signal can be determined on the basis of the reception scheme of the other communication device (e.g., reception diversity or adaptive array). One of the communication devices can also be designed so that the transmission power determined by open-loop transmission power control can be further corrected on the basis of necessary received power information from the other communication device.

### Embodiment 2

Embodiment 2 of the present invention will be described with reference to the drawings.

Embodiment 2 can be described using the same FIGS. 1 to 3 as Embodiment 1. Embodiment 2 is also achieved by the mobile communication system 10. In Embodiment 2, the base station device 20 or the mobile station device 30 carries out transmission power control according to fluctuations in the received power.

FIG. 9 shows a relationship between a received power fluctuation index, which is information that indicates the fluctuation tendencies of the received power of the first communication device (e.g., mobile station device 30); and the necessary average received power of the second communication device (e.g., base station device 20) that receives a communication signal transmitted from the first communication device. As shown in this diagram, if the reception schemes are the same, the necessary average received power will increase as the received power fluctuation index increases; e.g., as fluctuations in the received power increase.

The base station device 20 and the mobile station device 30 carry out transmission power control using this relationship between the received power fluctuation index and the necessary average received power. The following is a description of a process in the mobile station device 30 for controlling the transmission power on the basis of the received power fluctuation index. This process is the same as the process in the base station device 20 for controlling the transmission power on the basis of the received power fluctuation index.

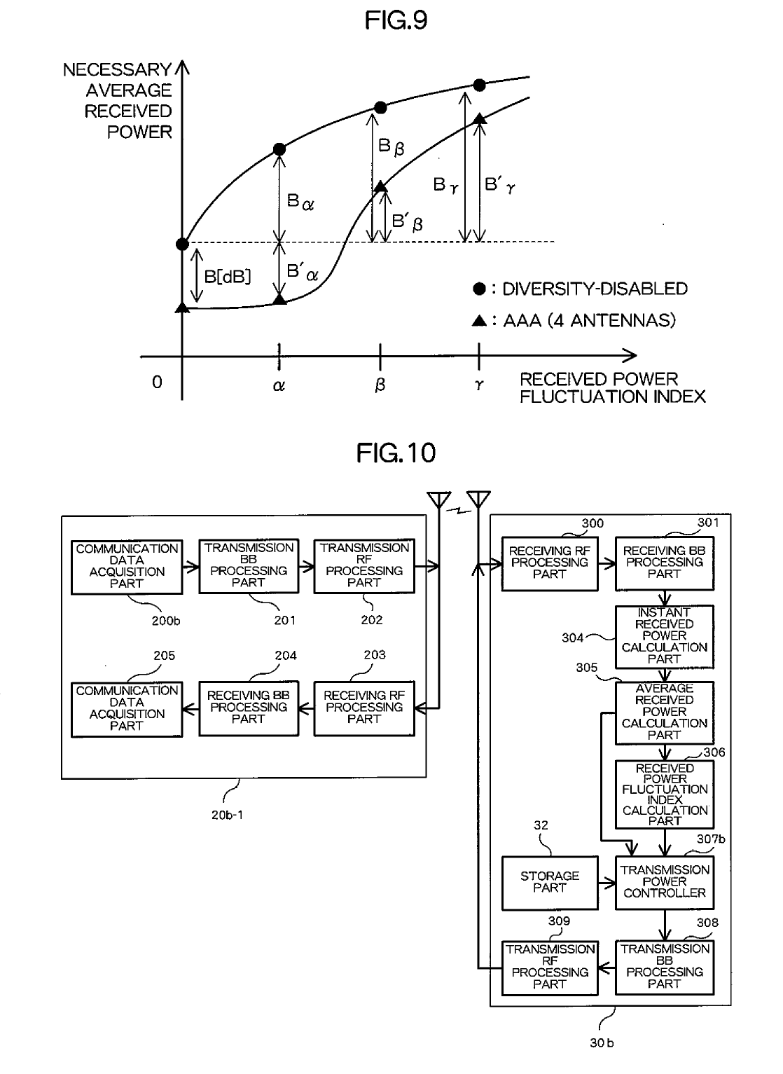

FIG. 10 is a functional block diagram of the base station device 20b and the mobile station device 30b according to the present embodiment. In this diagram, only one diversity-disabled device (base station device 20b-1) is represented as the base station device 20b.

As shown in FIG. 10, the base station devices 20b differ from the base station devices 20a in that the base station device 20b has a communication data acquisition part 200b instead of the communication data acquisition part 200a. The mobile station device 30b differs from the mobile station device 30a in that the mobile station device 30b has a received power fluctuation index calculation part 306, and not the communication data acquisition part 302 or the reception scheme acquisition part 303. The mobile station device 30b also has a transmission power controller 307b instead of the transmission power controller 307a. The storage part 32 stores a transmission power correction value storage table B instead of the transmission power correction value storage table A, as described below. The differences from Embodiment 1 will be described below.

The base station device 20b transmits communication data in the same manner as in the prior art. However, the mobile station device 30b outputs the average received power value calculated by the average received power calculation part 305 to the received power fluctuation index calculation part 306.

The received power fluctuation index calculation part 306 calculates the received power fluctuation index on the basis of the average received power value, and outputs the results to the transmission power controller 307b. Specifically, the received power fluctuation index calculation part 306 temporarily stores the average received power values for a prescribed number of cycles as an average received power value set. The received power fluctuation index calculation part 306 compares the amount of fluctuation in the average received power values in the average received power value set with a prescribed threshold value, whereby the average received power value set is classified into one of four levels. The received power fluctuation index calculation part 306 sets the level to which the average received power value set belongs as the received power fluctuation index. Specifically, the received power fluctuation index calculation part 306 sets the received power fluctuation index to 0 when the level to which the average received power value set belongs is the level that has the least amount of fluctuation; sets the received power fluctuation index to a when the level is the level of the next lowest fluctuation; sets the received power fluctuation index to β when the level is the level of the next lowest fluctuation; and sets the received power fluctuation index to γ when the level is the level of maximum fluctuation.

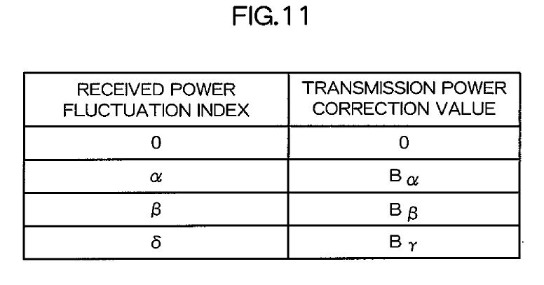

The transmission power controller 307b reads the transmission power correction value stored in the transmission power correction value storage table B from the storage part 32 according to the inputted received power fluctuation index. FIG. 11 is an example of the transmission power correction value storage table B. As shown in this diagram, in the transmission power correction value storage table B, the transmission power correction value is stored in correspondence with the received power fluctuation index. The transmission power controller 307b acquires the transmission power correction value stored in correspondence with the received power fluctuation index.

The transmission power controller 307b determines the transmission power on the basis of the acquired transmission power correction value. Specifically, the Equation (1) is modified as shown in Equation (2), and the Equation (2) is used. Y is the transmission power correction value acquired by the transmission power controller 307b.

Ptx=X+Y−Prx′ (2)

Since Y varies in real time, the calculation is carried out by adding Y directly in the Equation (2) in open-loop transmission power control, without the open-loop transmission power control parameter X being corrected in advance as in Embodiment 1. The transmission power controller 307b thus determines the transmission power value Ptx, and instructs the transmission BB processing part 308 to output a baseband signal at the transmission power having the determined transmission power value.

The mobile communication system 10 carries out transmission power control according to the fluctuation tendencies of the received power, as described above. Therefore, it is possible to carry out transmission power control according to the fluctuations in the received power as long as the fluctuation tendencies do not suddenly change. The communication device can also further correct the transmission power determined by the open-loop transmission power control on the basis of the received power fluctuation index.

### Embodiment 3

Embodiment 3 of the present invention will be described with reference to the drawings.

Embodiment 3 can be described using the same FIGS. 1 to 3 as Embodiment 1. Embodiment 3 is also achieved by the mobile communication system 10.

As shown in FIG. 9, the relationship between the received power fluctuation index of the first communication device and the necessary average received power of the second communication device vary according to the reception scheme of the second communication device that receives the communication signal transmitted from the first communication device. The base station device 20 and the mobile station device 30 carry out transmission power control using this relationship between the reception scheme, the received power fluctuation index, and the necessary average received power. The following is a description of a process in the mobile station device 30 for controlling the transmission power on the basis of the reception scheme and the received power fluctuation index. The same process is carried out in the base station device 20.

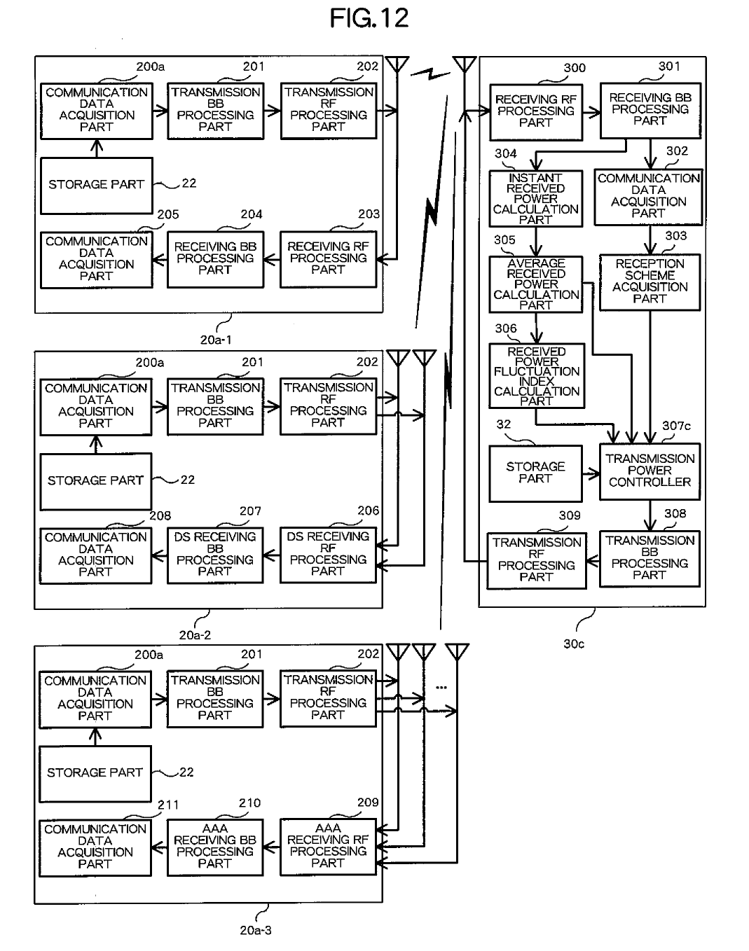

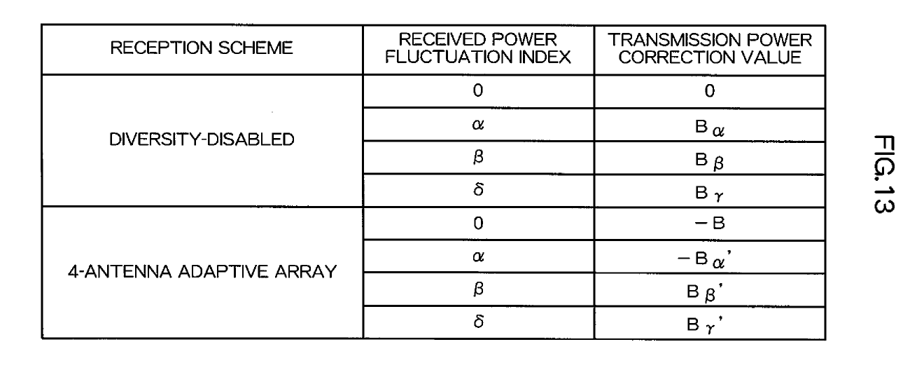

FIG. 12 is a functional block diagram of the base station devices 20a and the mobile station device 30c of the present embodiment.

As shown in FIG. 12, the base station devices 20a are the same as in Embodiment 1. The mobile station device 30c differs from the mobile station device 30a in that the mobile station device 30c has a received power fluctuation index calculation part 306. The received power fluctuation index calculation part 306 is the same as the received power fluctuation index calculation part provided to the mobile station device 30b. The mobile station device 30c has a transmission power controller 307c instead of the transmission power controller 307a. The storage part 32 stores a transmission power correction value storage table C instead of the transmission power correction value storage table A or transmission power correction value storage table B, as described below.

The transmission power controller 307c carries out transmission power control on the basis of the reception scheme information inputted from the reception scheme acquisition part 303; the average received power value inputted from the average received power calculation part 305; and the received power fluctuation index inputted from the received power fluctuation index calculation part 306.

Specifically, the transmission power controller 307c reads the transmission power correction value stored in the transmission power correction value storage table C from the storage part 32, according to the reception scheme indicated by the inputted reception scheme information and the received power fluctuation index. FIG. 13 is an example of the transmission power correction value storage table C. As shown in this diagram, in the transmission power correction value storage table C, the transmission power correction value is stored in correspondence with the reception scheme and the received power fluctuation index. The transmission power controller 307c acquires the transmission power correction value stored in correspondence with the reception scheme information and the received power fluctuation index.

The transmission power controller 307c determines the transmission power on the basis of the acquired transmission power correction value. Specifically, in the case that the reception scheme information is inputted, the transmission power controller 307c corrects the open-loop transmission power control parameter X by the same process as in Embodiment 1. Furthermore, the transmission power controller 307c determines the transmission power value Ptx by the same process as in Embodiment 2 each time the received power fluctuation index is inputted.

The transmission power controller 307c thus determines the transmission power value Ptx, and instructs the transmission BB processing part 308 to output a baseband signal at the transmission power having the determined transmission power value.

Next, the process in the mobile station device 30 will be described in detail with reference to a process flowchart.

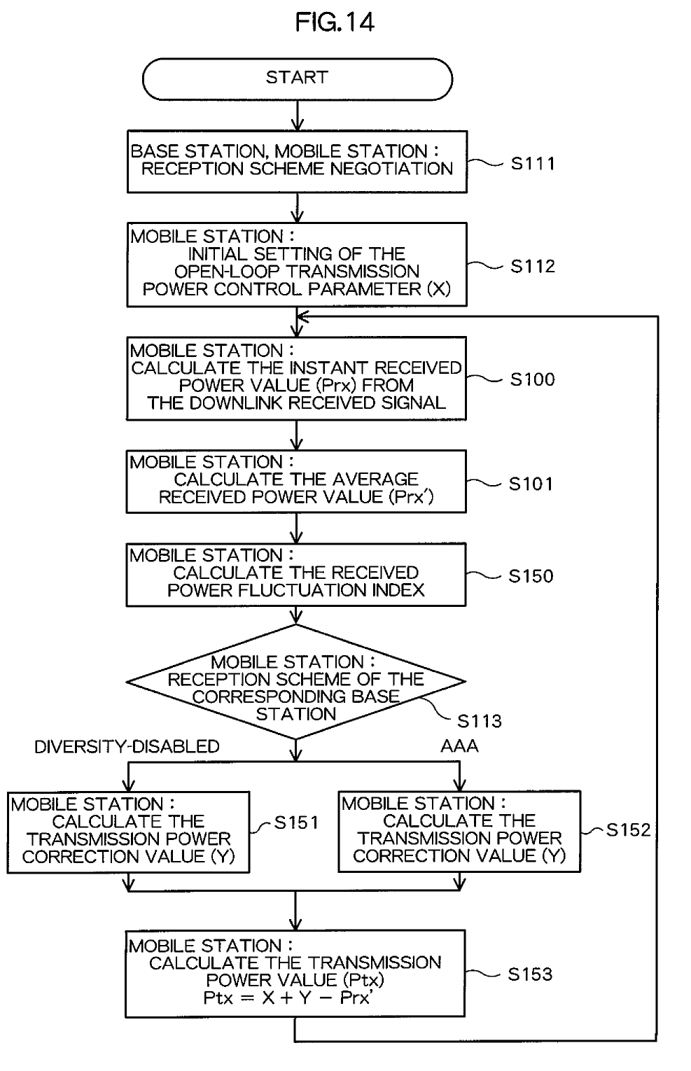

FIG. 14 is a flowchart of the basic process of the transmission power control in the mobile station device 30. As shown in this diagram, the mobile station device 30 first carries out the processes of S111, S112, S100, and S101 shown in FIGS. 7 and 8. The mobile station device 30 then calculates the received power fluctuation index on the basis of the average received power value (Prx′) calculated in S101 (S150).

The mobile station device 30 reads the transmission power correction value stored in correspondence with the calculated received power fluctuation index, in relation to the reception scheme of the base station device 20 that is in the process of communicating or that is about to begin communication, and determines the value of the transmission power correction value Y (S113, S151, S152). The mobile station device 30 then calculates the transmission power value Ptx by using the Equation (2) (S153). The mobile station device 30 transmits an uplink communication signal at the transmission power having the calculated transmission power value (Ptx). The mobile station device 30 returns to the process in S100 after the process in S153 is complete, and repeats the above processes while the communication is in progress. The mobile station device 30 thereby performs transmission signal control according to the fluctuation tendencies of the received power.

As described above, the communication device included in the mobile communication system 10 carries out transmission power control according to the reception scheme of a communication counterpart and the fluctuation tendencies of the received power of the communication device. According to this arrangement, the transmission power correction value is stored in correspondence with the received power fluctuation index for each of the reception schemes. The communication device can therefore acquire the transmission power correction value that is suitable for the calculated received power fluctuation index and the received reception scheme. The transmission power can be appropriately determined by correcting the transmission power on the basis of the transmission power correction value.

1. A communication system for carrying out communication between a first communication device and a second communication device, wherein
the second communication device comprises:
necessary received power information transmission means for transmitting necessary received power information related to a received power necessary to receive a communication signal; and the first communication device comprises:
necessary received power information receiving means for receiving the transmitted necessary received power information;
transmission power determining means for determining a transmission power at which a communication signal is transmitted on the basis of the received necessary received power information; and
first communication signal transmission means for transmitting the communication signal to the second communication device at the determined transmission power.

2. The communication system of claim 1, wherein
the necessary received power information is information indicating a reception scheme by which the second communication device receives the communication signal transmitted by the first communication signal transmission means.

3. The communication system of claim 1 or 2, wherein
the second communication device further comprises second communication signal transmission means for transmitting a communication signal; and
the first communication device further comprises:
communication signal receiving means for receiving the communication signal transmitted by the second communication signal transmission means; and
received power information acquisition means for acquiring received power information indicating a received power of the received communication signal; wherein
the transmission power determining means determines the transmission power at which the communication signal is transmitted further on the basis of the acquired received power information.

4. The communication system of claim 3, wherein the communication system wherein
the first communication device further comprises received power fluctuation index calculating means for calculating a received power fluctuation index indicating fluctuation tendencies of the received power indicated by the acquired received power information; and
the transmission power determining means determines the transmission power at which the communication signal is transmitted further on the basis of the calculated received power fluctuation index.

5. The communication system of claim 4, wherein
the first communication device further comprises:
storage means for storing a transmission power correction value in correspondence with the received power fluctuation index for each item of necessary received power information; and
the transmission power determining means corrects the received necessary received power information on the basis of the transmission power correction value stored in correspondence with the calculated received power fluctuation index; and determines the transmission power at which the communication signal is transmitted.

6. A communication device, characterized in comprising:
necessary received power information receiving means for receiving, from a receiving communication device, necessary received power information related to a necessary received power of the receiving communication device;
transmission power determining means for determining the transmission power at which a communication signal is transmitted on the basis of the received necessary received power information; and
communication signal transmission means for transmitting the communication signal to the receiving communication device at the determined transmission power.

7. The communication device of claim 6, wherein
the necessary received power information is information indicating a reception scheme by which the receiving communication device receives the communication signal transmitted by the communication signal transmission means.

8. A transmission power control method, comprising: a necessary received power information receiving step of receiving, from a receiving communication device, necessary received power information related to a necessary received power of the receiving communication device;
a transmission power determining step of determining the transmission power at which a communication signal is transmitted on the basis of the received necessary received power information; and
a communication signal transmitting step of transmitting the communication signal to the receiving communication device at the determined transmission power.
